(19) United States
(12) Patent Application Publication
(10) Pub. No.: US 2013/0180123 A1
(43) Pub. Date: Jul. 18, 2013

(54) APPLIANCE HAVING A DRYING RACK

(71) Applicants: Alexander D. James, Louisville, KY (US); Thomas G. Holzen, Louisville, KY (US); Paul S. Haney, Pewee Valley, KY (US)

(72) Inventors: Alexander D. James, Louisville, KY (US); Thomas G. Holzen, Louisville, KY (US); Paul S. Haney, Pewee Valley, KY (US)

(73) Assignee: GENERAL ELECTRIC COMPANY, Schenectady, NY (US)

(21) Appl. No.: 13/348,710

(22) Filed: Jan. 12, 2012

(51) Int. Cl. F26B 11/02; D06F 39/12; D06F 58/20; A47B 81/00

(52) U.S. Cl. 34/108; 312/228.1

(57) ABSTRACT

The present disclosure relates to appliances having a drying rack. The drying rack is rotatably mounted to a panel of the appliance. The drying rack may selectively shift between a storage configuration and an extended configuration. In the extended configuration, the drying rack may, e.g., support a hanger.

### FIELD OF THE INVENTION

The subject matter disclosed herein relates generally to an appliance having a drying rack for drying articles.

### BACKGROUND OF THE INVENTION

Certain dryer appliances dry articles (e.g., clothing) disposed within a drum of the appliance by heating the articles and tumbling them within the drum. When they are dry, certain articles should be removed from the drum quickly to avoid wrinkling. For example, certain articles should be removed quickly after drying and placed on hangers. However, placing articles on hangers can require users to load the articles into a basket and take the articles to a location that is more convenient for placing such articles on hangers. For example, some users purchase a rack to support hangers with articles disposed thereon. Thus, in such example, some users move the basket of articles to a location near the rack in order to place hangers with articles on the rack.

The process of removing articles from the drum and transporting them to another area for hanging can be inconvenient and add significantly to the amount of time and effort necessary to properly hang such articles. In addition, purchasing a rack for supporting hangers can add to the overall cost of cleaning laundry. Also, such racks can be easily lost or misplaced.

Accordingly, a drying rack that reduces the inconvenience associated with hanging certain articles on hangers would be useful. Further, a drying rack that also is not easily lost or misplaced would also be useful. In addition, a drying rack that would also not add significantly to the overall cost of cleaning laundry would be useful.

Also, a design goal for many washing machine appliances and dryer appliances is to have cosmetic appeal to consumers. Certain washing machine appliances and dryer appliances are sold in pairs. Accordingly, washing machine appliance and dryer appliance pairs can be manufactured so that both appliances have a similar cosmetically appealing appearance to consumers. Thus, certain washing machine appliances and dryer appliances can include decorative features such as, e.g., a band on the front panel of the appliances. In certain washing machine appliances, such bands can be incorporated into features of the appliance, e.g., a detergent dispensing door on front-loading washing machine appliances. However, in such example, because such doors must slide away from the front panel of the appliance, the band may be broken into two components, with a fixed portion mounted to the appliance's front panel and a drawer portion mounted to the drawer. Dryer appliances do not have a detergent dispensing drawer. Thus, in certain washing machine appliance and dryer appliance pairs, the dryer appliance can require a single continuous decorative band rather than the two piece design used on the matching washing machine appliance. Producing two cosmetically similar but structurally distinct bands can add to the overall cost of producing such washing machine appliance and dryer appliance pairs.

Accordingly, a drying rack that can be incorporated into a band on a front panel of a dryer appliance in order to create a single band design for the dryer appliance and a matching washing machine appliance would be useful.

### BRIEF DESCRIPTION OF THE INVENTION

Aspects and advantages of the invention will be set forth in part in the following description, or may be obvious from the description, or may be learned through practice of the invention.

In a first exemplary embodiment, an appliance is provided. The appliance has a cabinet with a front panel. The front panel defines a pocket extending longitudinally from a first end to a second end. The first and second ends of the pocket are positioned adjacent an exterior surface of the front panel. A drum is rotatably mounted within the cabinet. The drum defines a chamber for receipt of articles. A rack is configured for receipt into the pocket of the cabinet. The rack extends longitudinally from a proximal end to a distal end. The proximal end of the rack is rotatably hinged to the cabinet at the first end of the pocket. The rack is configured for selective adjustment between a storage configuration and an extended configuration. In the storage configuration, the distal end of the rack is positioned adjacent the second end of the pocket such that the rack is disposed within the pocket of the cabinet. In the extended configuration, the distal end of the rack is positioned outside of the pocket of the cabinet such that the rack projects away from the front panel of the cabinet.

In a second exemplary embodiment, an appliance is provided. The appliance has a cabinet with a front panel. A drum is rotatably mounted within the cabinet. The drum defines a chamber for receipt of articles. A band is disposed on the front panel of the cabinet. The band extends longitudinally from a first end to a second end. The band has a fixed portion fixedly mounted to the cabinet. The fixed portion extends from the first end of the band towards the second end of the band. The band also has a rack portion rotatably mounted to the cabinet. The rack portion is configured for selective adjustment between a storage configuration and an extended configuration. In the storage configuration, an exterior surface of the rack portion and an exterior surface of the fixed portion are substantially flush. In the extended configuration, the rack portion projects away from the front panel of the cabinet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a dryer appliance according to an exemplary embodiment of the present subject matter, a drying rack in a storage configuration is also shown;

FIG. 2 provides a perspective view of the exemplary dryer appliance of FIG. 1 with a portion of a cabinet of the dryer appliance removed to reveal an interior of the dryer appliance;

FIG. 3 illustrates a perspective view of the exemplary dryer appliance of FIG. 1 with the drying rack in an extended configuration;

FIG. 4 illustrates a perspective view of the exemplary dryer appliance of FIG. 1 with the drying rack in an extended configuration with a pair of hangers disposed thereon.

### DETAILED DESCRIPTION OF THE INVENTION

The present disclosure relates to appliances having a drying rack. The drying rack is rotatably mounted to a panel of the appliance. The drying rack may selectively shift between a storage configuration and an extended configuration. In the extended configuration, the drying rack may, e.g., support a hanger. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

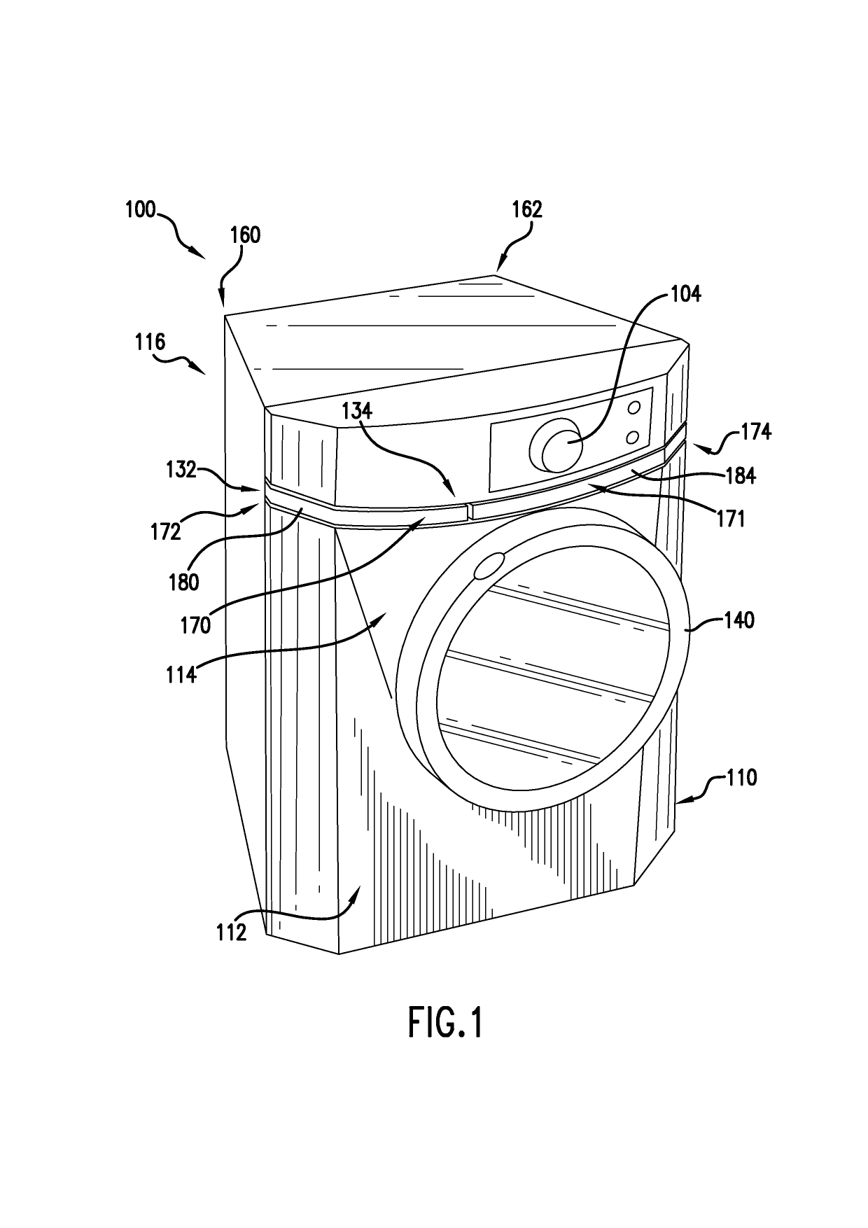

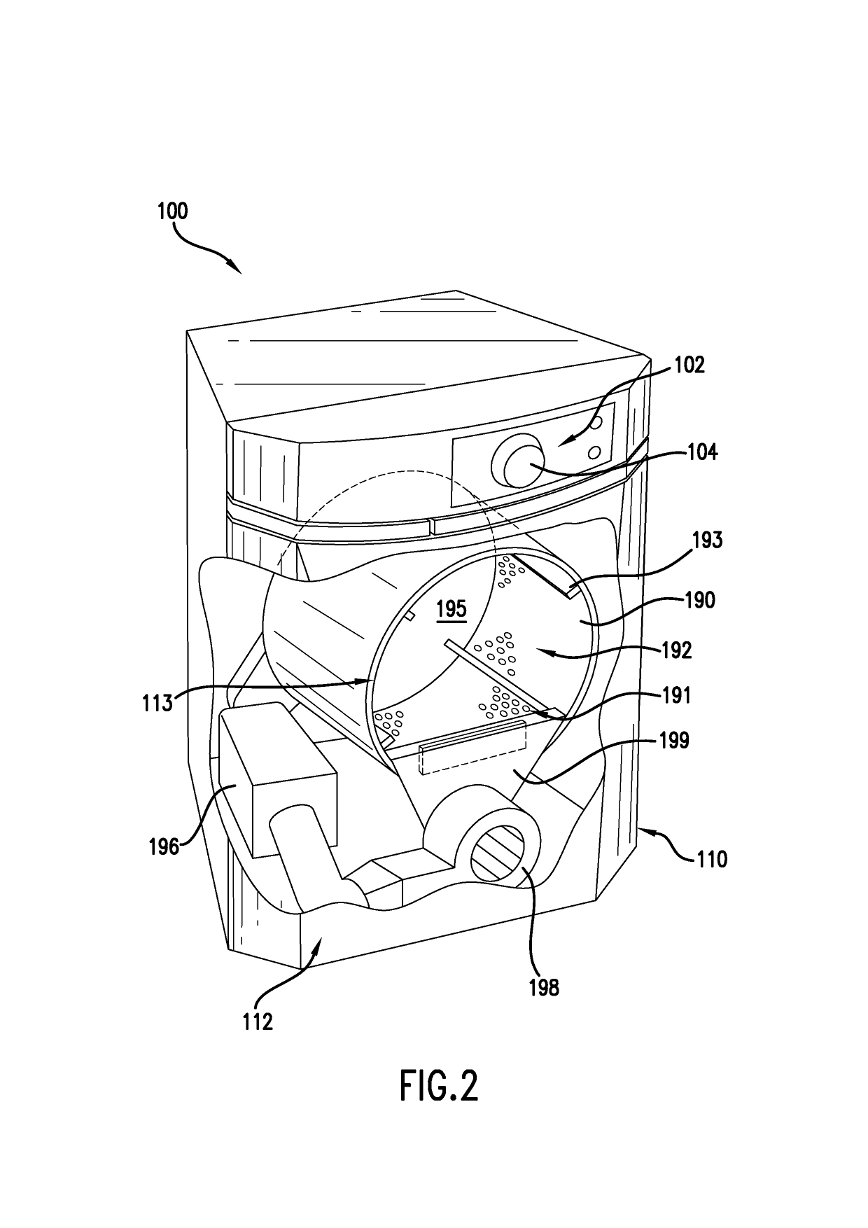

FIGS. 1 and 2 provide perspective views of a dryer appliance 100 according to an exemplary embodiment of the present subject matter. However, while described in the context of a specific embodiment of dryer appliance 100, using the teachings disclosed herein it will be understood that dryer appliance 100 is provided by way of example only. Other dryers having different appearances and different features may also be utilized with the present invention as well. In addition, the teachings disclosed herein may be used with other appliances as well, e.g., a washing machine appliance.

The dryer appliance 100 includes a main housing or cabinet 110 with a drum 190 rotatably mounted therein. Drum 190 defines a drying chamber 192 configured for receipt of articles for drying. Cabinet 110 also has a door 140 rotatably mounted to front panel 112. Door 140 provides selective access to drying chamber 192. A motor (not shown) rotates drum 190 about a horizontal axis. Drum 190 is generally cylindrical in shape and defines a plurality of holes 191. An opening 113 is defined by drum 190 in order to allow a user to access to drying chamber 192, e.g., for loading and unloading of articles (e.g., clothing and/or other fabrics) into drying chamber 192.

A plurality of tumbling ribs 193 are provided within drum 190 to lift articles disposed therein and then allow them to tumble back to the bottom of drum 190 as drum 190 rotates. Drum 190 also includes a rear wall 195 rotatably supported within cabinet 110 by a suitable fixed bearing. Rear wall 195 can be fixed or can be rotatable. Plurality of holes 191 receive hot air that has been heated by a heating system 196. Air is drawn from drum 190 by a blower fan 198. The air passes through a lint or screen filter 199 which traps lint particles. As the air passes from the blower fan 198, it is passed into the heating system 196. Heated air exits heating system 196 and returns to drum 190. After they have been dried, the articles are removed from drum 190 via opening 113.

A cycle selector knob 104 is mounted on front panel 112 and is in communication with a processing device or controller (not shown) connected with a user interface panel 102. Signals generated in the controller operate the drum drive system and heating system 196 in response to the user manipulation of the selector knobs 104. Alternatively, a touch screen type interface may be provided. As used herein, “processing device” or “controller” may refer to one or more microprocessors or semiconductor devices and is not restricted necessarily to a single element. The processing device can be programmed to operate dryer appliance 100 according to methods well known in the art. The processing device may include, or be associated with, one or memory elements such as e.g., electrically erasable, programmable read only memory (EEPROM).

In FIG. 1, a band 170 is disposed on front panel 112 of cabinet 110 and positioned adjacent a top 116 of cabinet 110. Band 170 extends longitudinally between a first end 172 and a second end 174 such that first end 172 of band 170 is on a first side 160 of front panel 112 and second end 174 of band 170 is on a second side 162 of front panel 112. Thus, as shown in FIG. 1, band 170 is substantially horizontally mounted to front panel 112. However, in alternative embodiments, band 170 may be mounted to front panel in any suitable manner (e.g., vertically). Also, in FIG. 1, band 170 is mounted to front panel 112 such that exterior surface 171 of band 170 and exterior surface 114 of front panel 112 are substantially flush. However, in alternative embodiments, exterior surface 171 of band 170 and exterior surface 114 of front panel 112 need not be substantially flush in the storage configuration.

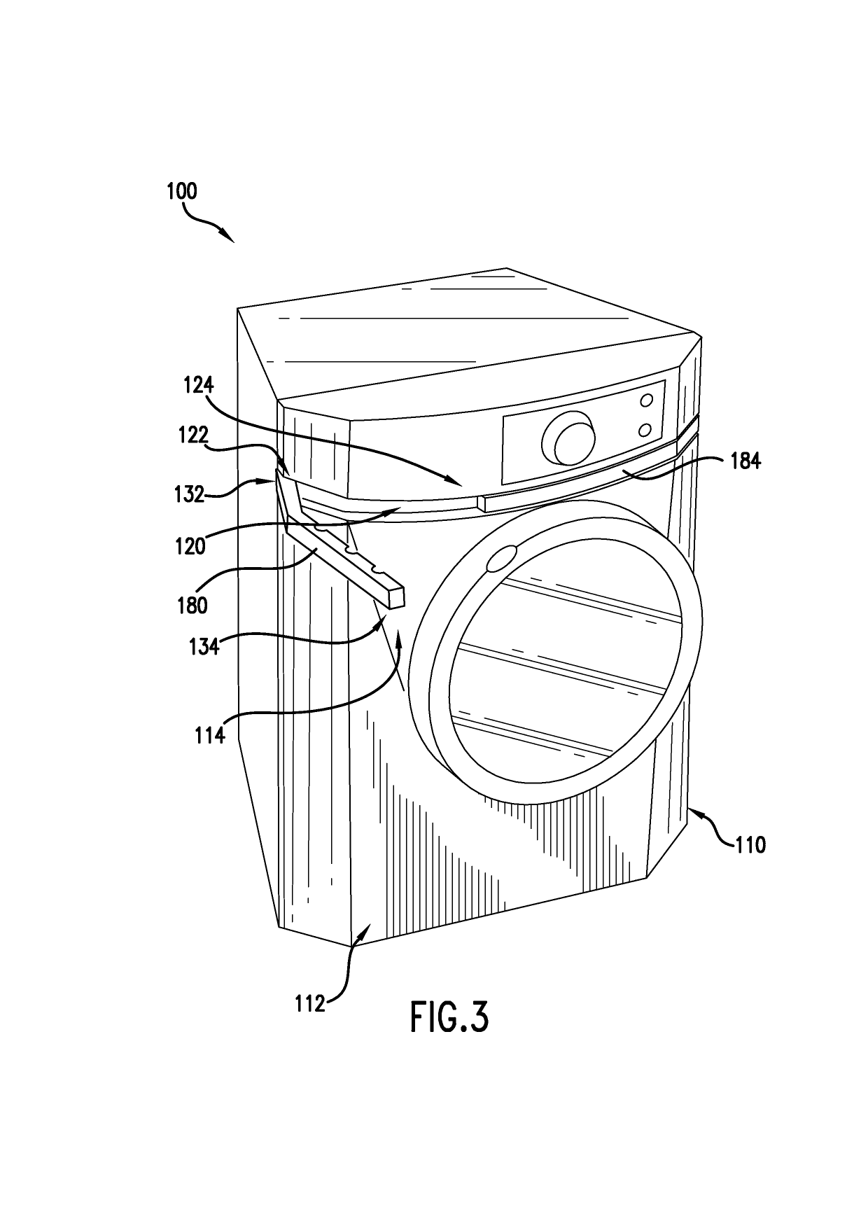

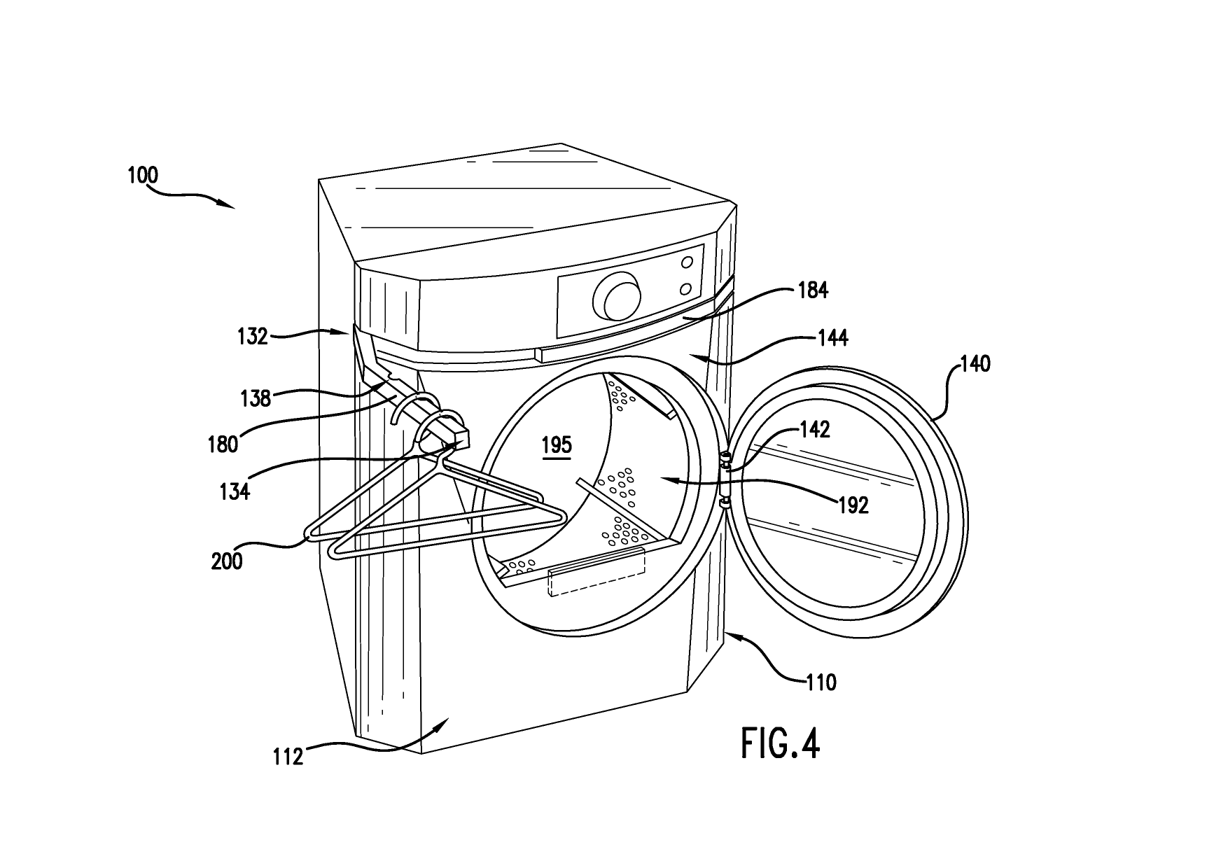

Band 170 includes a fixed portion 180 and a rack portion 184. Fixed portion 180 is fixedly mounted to front panel 112 and extends from first end 172 of band 170 towards second end 174 of band 170. Rack portion 184 of band 170 is rotatably mounted to front panel 112 such that rack portion 184 may be selectively adjusted between a storage configuration shown in FIGS. 1 and 2 and an extended configuration shown in FIGS. 3 and 4. Rack portion 184 extends between a proximal end 132 and a distal end 134. Proximal end 132 of rack portion 184 is rotatable hinged to cabinet 110 such that distal end 134 of rack portion 132 may selectively rotate away from cabinet 110 (as shown in FIGS. 3 and 4). It should be understood by those skilled in the art that rack portion 184 may be mounted to cabinet without fixed portion 180 and/or band 170. Thus, a rack rotatably mounted to cabinet 110 may be provided, e.g., when other portions of band 170 are not needed and/or desired.

In FIG. 1, rack portion 184 is in the storage configuration. In the storage configuration, rack portion 184 is received in a pocket 120 (shown in FIGS. 3 and 4) defined by front panel 112 such that distal end 134 of rack portion 184 is disposed within pocket 120.

FIGS. 3 and 4 illustrate perspective views of the dryer appliance 100 of FIG. 1 with rack portion 184 in the extended configuration. As may be seen in FIG. 3, pocket 120 extends longitudinally between a first end 122 and a second end 124. First and second ends 122,124 of pocket 120 are positioned adjacent an adjacent an exterior surface 114 of front panel 112. In the storage configuration shown in FIG. 1, distal end 134 of rack portion 184 is positioned adjacent second end 124 of pocket 120. Also, in FIG. 1, an exterior surface 186 of rack portion 184 is flush with an exterior surface 182 of fixed portion 180 and with exterior surface 114 of front panel 112. However, in alternative embodiments, exterior surface 186 of rack portion 184 need not be flush with exterior surface 182 of fixed portion 180 and/or with exterior surface 114 of front panel 112 in the storage configuration.

As shown in FIGS. 3 and 4, in the extended configuration, distal end 134 of rack portion 184 is positioned outside of pocket 120 such that rack portion 134 projects away from front panel 112 of cabinet 110. Also, rack portion 134 defines a plurality of slots 138. As shown in FIG. 4, plurality of slots 138 is configured for receipt of hangers 200. Thus, plurality of slots 138 may support hangers 200 when rack portion 184 is in the extended configuration.

As may be seen in FIGS. 1 and 3, rack portion 184 rotates away from front panel 112 of cabinet 110 in a first direction when rack portion 184 adjusts from the storage configuration shown in FIG. 1 to the extended configuration shown in FIG. 3. Similarly, door 140 may rotate between a closed configuration shown in FIG. 1 and an open configuration shown in FIG. 4 by rotating in a second direction. The first and second directions being opposite relative to one another. Thus, as shown in FIG. 4, door 140 is mounted to front panel 112 with a hinge 111. Hinge 111 is positioned on a second side 162 of cabinet 110 and proximal end 132 of rack portion 184 is positioned on a first side 160 of cabinet 110.

As shown in FIGS. 1 and 3, rack portion 184 is configured for selective adjustment between the storage configuration and the extended configuration. During operation of dryer appliance 100, rack portion 184 may be in the storage configuration shown in FIG. 1 such that rack portion 184 is disposed within pocket 120. By disposing rack portion 184 in pocket 120, rack portion 184 is, e.g., prevented from snagging objects or otherwise unintentionally interfering with a user. However, after articles disposed in chamber 192 have been dried by dryer appliance 100, a user may remove the article from chamber 192. The user may desire to place certain articles on hangers 200. After placing such articles on hangers 200, the user may desire to support (i.e., hang) hangers 200, e.g., in order to prevent articles disposed thereon from wrinkling Thus, the user may adjust rack portion 184 from the storage configuration shown in FIG. 1 to the extended configuration in shown in FIG. 3. In the storage configuration, the user may place a hanger 200 in a particular one of the plurality of slots 138 so that the hanger 200 is securely supported by rack portion 184. Accordingly, the location of rack portion 184 (e.g., adjacent top 116 of cabinet 110) permits the user to remove articles directly from chamber 192 and place articles on hangers 200 and in turn on rack portion 184 without having to transport such articles to another location. When finished, e.g., when the user removes the hanger 200 from rack portion 184, the user may adjust rack portion 184 back to the storage configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a cabinet having a front panel, the front panel defining a pocket extending longitudinally from a first end to a second end, the first and second ends of the pocket positioned adjacent an exterior surface of the front panel;
a drum rotatably mounted within said cabinet, said drum defining a chamber for receipt of articles; and
a rack configured for receipt into the pocket of said cabinet, the rack extending longitudinally from a proximal end to a distal end, the proximal end of said rack being rotatably hinged to said cabinet at the first end of the pocket, said rack being configured for selective adjustment between a storage configuration and an extended configuration, wherein:
in the storage configuration, the distal end of said rack is positioned adjacent the second end of the pocket such that said rack is disposed within the pocket of said cabinet; and
in the extended configuration, the distal end of said rack is positioned outside of the pocket of said cabinet such that said rack projects away from the front panel of said cabinet.

2. The appliance of claim 1, wherein the pocket is positioned adjacent a top portion of said cabinet.

3. The appliance of claim 1, wherein an exterior surface of said rack is flush with the exterior surface of the front panel in the storage configuration.

4. The appliance of claim 1, wherein said rack is substantially horizontal in the storage configuration.

5. The appliance of claim 1, further comprising a door rotatably mounted to said cabinet with a hinge, said door permitting selective access to the chamber of said drum, wherein the front panel of said cabinet has a first side and a second side, the hinge positioned on the second side of the front panel, and the first end of said pocket positioned on the first side of the front panel.

6. The appliance of claim 1, further comprising a door rotatably mounted to said cabinet with a hinge, said door permitting selective access to the chamber of said drum, wherein said door rotates from a closed configuration to an open configuration in a first direction, and said rack rotates from the storage configuration to the extended configuration in a second direction, the second direction being an opposite of the first direction.

7. The appliance of claim 1, wherein said rack defines a plurality of slots, each of the slots being configured for receiving a hanger.

8. The appliance of claim 1, wherein said appliance is a washing machine appliance.

9. The appliance of claim 1, wherein said appliance is a dryer appliance.

10. An appliance comprising:
a cabinet having a front panel;
a drum rotatably mounted within said cabinet, said drum defining a chamber for receipt of articles; and
a band disposed on the front panel of said cabinet, said band extending longitudinally from a first end to a second end, said band comprising:
a fixed portion fixedly mounted to said cabinet, the fixed portion extending from the first end of said band towards the second end of said band; and
a rack portion rotatably mounted to said cabinet, said rack portion being configured for selective adjustment between a storage configuration and an extended configuration, wherein:
in the storage configuration, an exterior surface of said rack portion and an exterior surface of said fixed portion are substantially flush; and
in the extended configuration, said rack portion projects away from the front panel of said cabinet.

11. The appliance of claim 1, wherein said band is positioned adjacent a top portion of said cabinet.

12. The appliance of claim 1, wherein the exterior surface of said rack portion is flush with an exterior surface of said front panel in the storage configuration.

13. The appliance of claim 1, wherein said rack portion is substantially horizontal in the storage configuration.

14. The appliance of claim 1, further comprising a door rotatably mounted to said cabinet with a hinge, said door permitting selective access to the chamber of said drum, wherein the front panel of said cabinet has a first side and a second side, the hinge positioned on the second side of the front panel and said rack portion positioned on the first side of the front panel.

15. The appliance of claim 1, further comprising a door rotatably mounted to said cabinet with a hinge, said door permitting selective access to the chamber of said drum, wherein said door rotates from a closed configuration to an open configuration in a first direction, said rack portion rotates from the storage configuration to the extended configuration in a second direction, the second direction being an opposite of the first direction.

16. The appliance of claim 1, wherein said rack portion defines a plurality of slots, each of the slots being configured for receiving a hanger.

17. The appliance of claim 1, wherein said appliance is a washing machine appliance.

18. The appliance of claim 1, wherein said appliance is a dryer appliance.
